(19) United States
(12) Patent Application Publication
(10) Pub. No.: US 2024/0227015 A1
(43) Pub. Date: Jul. 11, 2024

(54) METHOD AND SYSTEM FOR CALIBRATING AN ADDITIVE MANUFACTURING SYSTEM

(71) Applicant: SANDVIK MACHINING SOLUTIONS AB, Sandviken (SE)

(72) Inventors: Per VIKLUND, Sandviken (SE); Ville-Pekka MATILAINEN, Sandviken (SE)

(21) Appl. No.: 18/561,770

(22) PCT Filed: May 18, 2022
(86) PCT No.: PCT/EP2022/063384

§ 371 Date: Nov. 17, 2023

(30) Foreign Application Priority Data
May 20, 2021 (SE) 2130136-1

(51) Int. Cl. B22F 10/31; B22F 12/30; B22F 12/90; B33Y 30/00; B33Y 50/02

(52) U.S. Cl. CPC B22F 10/31; B22F 12/30; B22F 12/90; B33Y 30/00; B33Y 50/02

(57) ABSTRACT

A method for calibrating an additive manufacturing system for manufacturing a hybrid article is provided. The additive manufacturing system includes at least one measuring device and a build plate. The build plate includes at least one fixture having a base device and at least one calibration feature, wherein the calibration feature is arranged to have its position determined by the at least one measuring device. The method includes measuring a position of the at least one calibration feature using the at least one measuring device and determining a relative position between the measuring device the at least one calibration feature. The method further includes determining the relative position between the measuring device and each corresponding base device, based on the relative position between the measuring device and the calibration feature, and calibrating the additive manufacturing system based on the determined relative positions.

### TECHNICAL FIELD

The present disclosure relates generally to methods, systems and for calibrating an additive manufacturing system, particularly for calibrating an additive manufacturing system for manufacturing a hybrid article.

### BACKGROUND

Additive manufacturing, also known as 3D printing, generally involves manufacturing, or printing, one layer at a time using specialized systems. In particular, a layer of material may be deposited on the working surface of a build chamber and bonded with another layer of the same or of a different material. Additive manufacturing may be used to manufacture articles from computer-aided design models using techniques such as powder bed fusion (PBF) and binder jetting.

In some applications, additive manufacturing may be used to manufacture an article on top of a pre-manufactured base device, commonly referred to as a blank, and such articles are often referred to as hybrid articles. The base devices are positioned on a build plate of the additive manufacturing system.

When manufacturing hybrid articles, it is crucial to have accurate information regarding the position of the base device, in order to position the article correctly on top of the base device. However, the build plate is usually inserted into the additive manufacturing slightly differently each time, which entails that the base devices will also have different positions between batches.

The additive manufacturing system generally has a system for determining the position of objects inside of it, including a measuring device such as a laser. However, measuring the position of the base devices may negatively impact the base devices. Furthermore, there may be a plurality of base devices, making it time consuming to measure the position of each one.

It would be beneficial if better ways of determining the positions of base devices in an additive manufacturing system could be achieved, without negatively impacting the base devices themselves.

### SUMMARY

It is an object of the invention to address at least some of the problems and issues outlined above. An object of embodiments of the invention is to provide a way to calibrate an additive manufacturing device for manufacturing hybrid articles, in a way that does not negatively impact the base devices on top of which articles are to be manufactured.

According to one aspect a method for calibrating an additive manufacturing system for manufacturing a hybrid article is provided. The additive manufacturing system comprises at least one measuring device, and a build plate comprising at least one base device and at least one calibration feature, wherein the calibration feature is adapted to have its position determined by the at least one measuring device. The method comprises measuring a position of the at least one calibration feature using the at least one measuring device and determining a relative position between the measuring device the at least one calibration feature. The method further comprises determining the relative position between the measuring device and each corresponding base device, based on the relative position between the measuring device and the calibration feature, and calibrating the additive manufacturing system based on the determined relative positions.

According to another aspect, a build plate for an additive manufacturing system, is provided, wherein the additive manufacturing system comprises at least one measuring device. The build plate comprises at least one calibration feature adapted to have its position determined by the at least one measuring device, and at least one fixture for a base device, wherein each base device, when attached to a fixture, has at least one corresponding calibration feature, and each calibration feature has a corresponding measuring device.

According to another aspect, an additive manufacturing system is provided. The additive manufacturing system comprises an additive manufacturing device, and a build plate comprising at least one fixture comprising a base device, and at least one calibration feature. The additive manufacturing system further comprises processing circuitry and a memory, the memory containing instructions executable by said processing circuitry. The additive manufacturing system is operative for measuring a position of the at least one calibration feature using the at least one measuring device and determining a relative position between the measuring device the at least one calibration feature. The additive manufacturing system is further operative for determining the relative position between the measuring device and each corresponding base device, based on the relative position between the measuring device and the calibration feature, and calibrating the additive manufacturing system based on the determined relative positions.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 shows a build plate comprising four calibration features and a plurality of base devices, according to an embodiment.

FIG. 2 shows a calibration feature on a build plate, according to an embodiment.

FIG. 3 shows a calibration feature with an imprinted pattern thereon, according to an embodiment.

FIG. 4 shows a block schematic of steps of a method for calibrating an additive manufacturing system according to an embodiment.

FIG. 5 shows a block schematic of parts of an additive manufacturing system according to an embodiment.

### DETAILED DESCRIPTION

Briefly described, the present disclosure relates to a method for determining the position of a base device, or a plurality of base devices, in an additive manufacturing system using a modified build plate. The additive manufacturing system comprises at least one measuring device and the modified build plate. The modified build plate comprises at least one base device and at least one calibration feature, adapted such that the position of the calibration feature can be determined using a measuring device of the additive manufacturing system, and that the position of each base device can be determined based on the position of the calibration feature. The method comprises measuring a position of the calibration feature using the measuring device, determining a relative position between the calibration feature and the measuring device, and then determining a relative position between the measuring device and each corresponding base device, based on the measured position.

A key insight relevant for the present disclosure is that by including a relatively simple calibration feature in a build plate, with a known relationship to each base device on the build plate, and which is adapted to have its position determined by a measuring device of the additive manufacturing system, a fast and accurate way of determining the position of each base device may be achieved, which does not negatively impact the base devices.

The measuring devices in additive manufacturing systems are often lasers, and determining the position of an object inside the additive manufacturing system comprises scanning the object with the laser. Such scanning can negatively impact the object being scanned due to the heat of the laser, and thus it may be disadvantageous to scan a base device, and instead provide another feature adapted for that purpose.

For the purpose of this disclosure, a base device is a device upon which an article is to be manufactured using additive manufacturing technologies. According to some embodiments, the base device is a generic machine interface, such as a Capto, HSK or similar, and the tool is a turning tool, milling tool or drilling tool. In some embodiments, the base device is intended to form a part of the finished article, such that the finished article is constituted by the base device and the article manufactured on top of the base device.

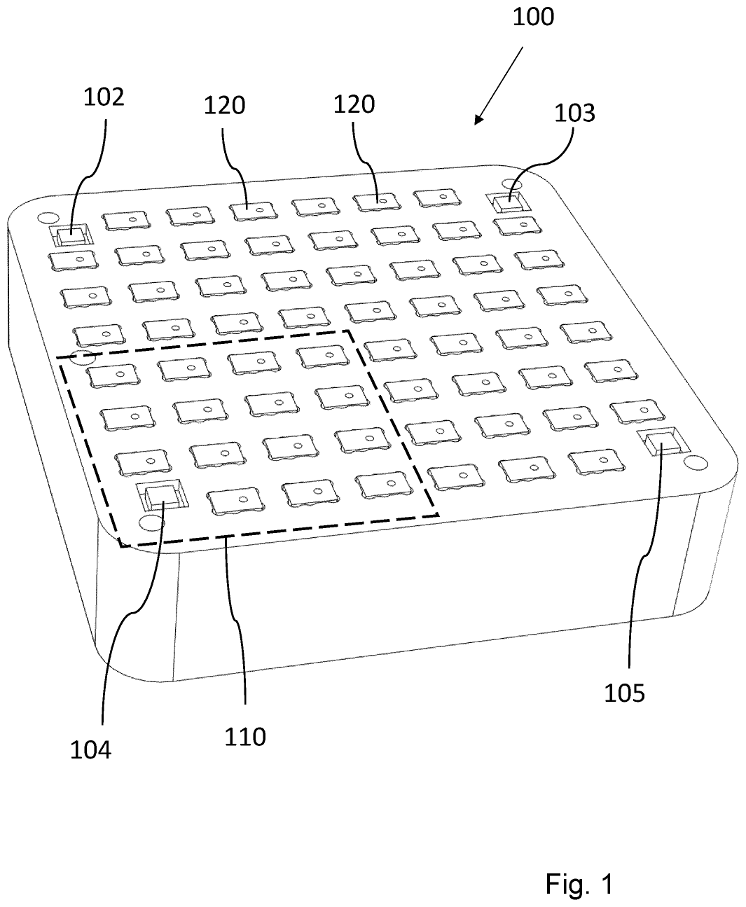

FIG. 1 shows an example of a build plate 100 according to an embodiment, comprising a plurality of base devices 120, and four calibration features 102, 103, 104, 105. The base devices 120 are attached to fixtures in the build plate, not shown in the figure. Each calibration feature 102, 103, 104, 105 has plurality of corresponding base devices 120, which may also be seen as having a plurality of corresponding fixtures, in some embodiments such that each base device or fixture is considered to correspond to the closest calibration feature. For example, in the build plate 100 shown in FIG. 1, the bottom left calibration feature 104 may have 15 corresponding base devices, shown by the dashed line 110. The other calibration features 102, 103, 105 may similarly have 15 corresponding base devices each.

In some embodiments, the build plate 100 is adapted such that there is one calibration feature per measuring device in the additive manufacturing system, and that each calibration feature is measured by a different measuring device. In some embodiments, there is at least one measuring device per calibration feature. In some embodiments, there is precisely one measuring device per calibration feature. In some embodiments, comprising a plurality of measuring devices and a plurality of calibration features, each measuring device can measure each calibration feature. Further, the step of measuring the position of each calibration feature may also have the function of calibrating the measuring devices.

The relative position between each calibration feature 102, 103, 104, 105 and its corresponding base devices is known, and thus the position of each base device may be determined based on the position of the calibration feature. In some embodiments, the position between each calibration feature 102, 103, 104, 105 and each base device 120 on the build plate is known.

In some embodiments, the calibration feature is machined into the build plate 100. In some embodiments, the build plate may comprise a recess, into which the calibration feature can be positioned securely and accurately.

The calibration feature 102, 103, 104, 105 is adapted to have its position determined by a measuring device of the additive manufacturing system. This entails at least that the feature comprises a material which is not too negatively impacted by the conditions of the additive manufacturing system.

In some embodiments, the calibration feature comprises at least one edge, for facilitating the position determining. In some embodiments, the calibration feature comprises at least two edges. In some embodiments, the calibration feature has a substantially flat top surface, for facilitating position determining. In some embodiments, the calibration feature is adapted such that it is possible to imprint a pattern into it using a measuring device of the additive manufacturing system.

In some embodiments, the position determination of the calibration feature, and the subsequent position determination of the base devices, may be performed automatically, such that the position of the calibration feature is determined inside of the additive manufacturing system, and the subsequent operations may be performed without removing the build plate from the additive manufacturing system.

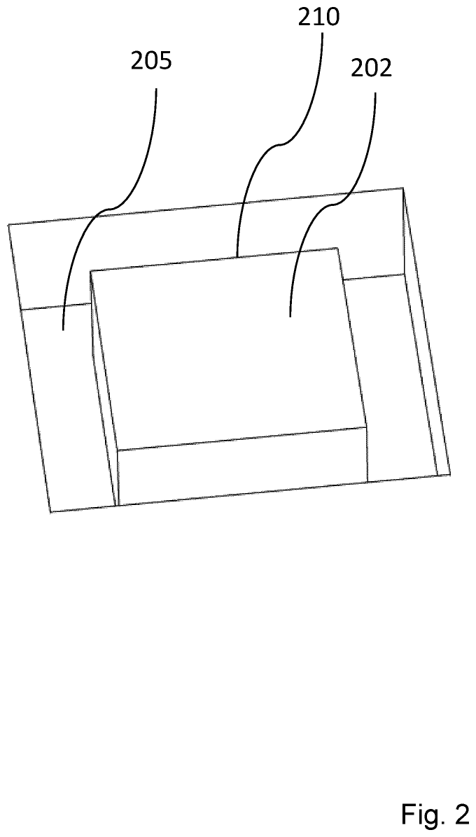

FIG. 2 shows a closeup of a calibration feature 202, in an embodiment in which the position determination of the calibration feature 202 may be performed automatically within the additive manufacturing system. In such embodiments, the calibration feature 202 may be surrounded by a clearance 205 and comprise at least one edge 210, such that there is a height different between the edges of the calibration feature 202 and the surrounding build plate. The dimensions of the clearance will depend on the capabilities of the measuring device, such that the measuring device is able to register the difference in height. In some embodiments, the clearance 205 is between 3 and 30 mm in width and depth. In some embodiments, the clearance is approximately 10 mm in width and depth.

By having such a height different, there is a clear and distinct break between the edges of the calibration feature 202 and the surrounding build plate, which is advantageous for making an accurate and fast determination of the position of the calibration feature 202. In some embodiments, the calibration feature 202 comprises at least two edges. As can be seen, the calibration feature 202 of FIG. 2 comprises four edges.

For the purpose of this disclosure, an edge is considered to be formed between two surfaces which have an angle of 90 degrees or less in between them. A purpose of the edge 106 is that a light source, e.g. a laser constituting a measuring device, which is applied over the edge should provide a clear break in its reflection when it passes the edge, which may make determination and subsequent analysis of the reflection easier and faster.

One edge is considered distinct from another if there is an angle between the two edges which is larger than 5 degrees. A reason for having a plurality of edges is that each edge may constitute a data point used for determining the position of the calibration feature, and by having a plurality of edges a plurality of data points can be used, which may be advantageous for position determining purposes.

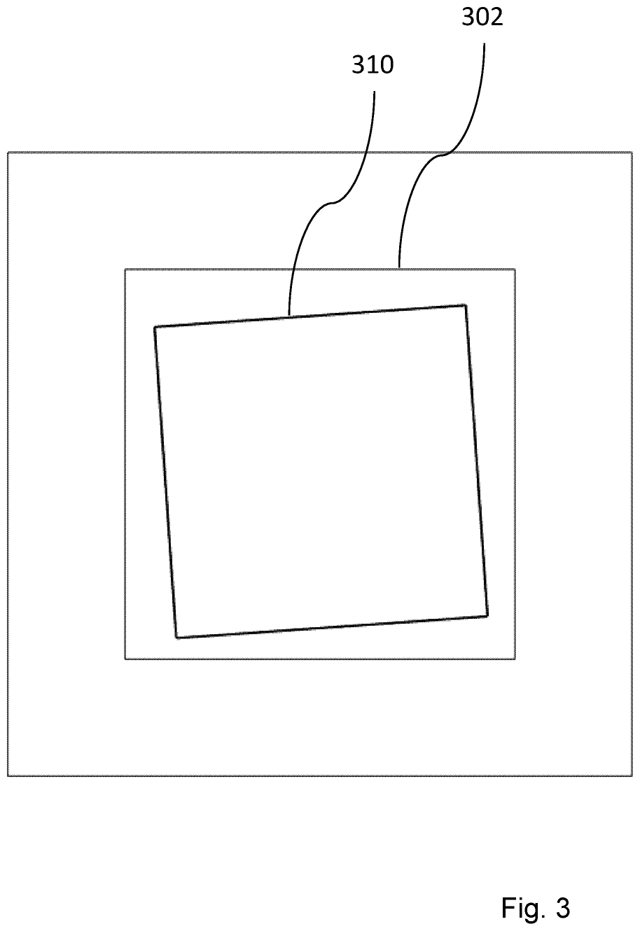

FIG. 3 shows a closeup of another embodiment of a calibration feature 302, in which the position determination of the calibration feature 302 may be performed by imprinting a pattern 310 on the calibration feature 302, using the measuring devices of the additive manufacturing system, and then removing the calibration feature 302 from the additive manufacturing system in order to inspect the imprinted pattern. In some embodiments, this may entail removing the entire build plate comprising the calibration feature, and in some embodiments it may entail removing the calibration feature from the build plate without removing the build plate from the additive manufacturing system.

Any differences between the expected shape of the pattern and the measured shape of the pattern may then be used to calibrate the additive manufacturing system.

In some embodiments, the calibration feature comprises a heat resistant material. In some embodiments, the calibration feature comprises a reflective material.

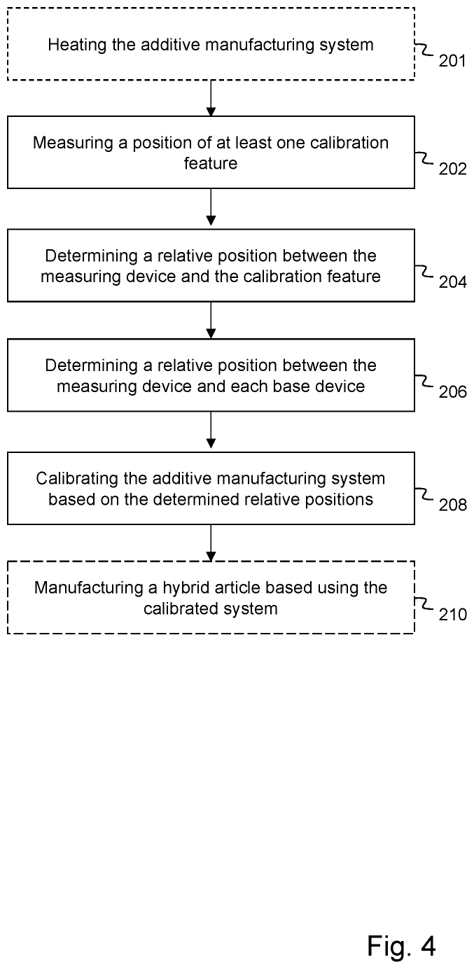

Looking now at FIG. 4, steps of a method for calibrating an additive manufacturing system according to an embodiment will now be described. The additive manufacturing system comprises a build plate, wherein the build plate comprises at least one base device and at least one calibration feature, and wherein the relative positions between each calibration feature and its corresponding base device(s) is known. The position of the measuring devices within the additive manufacturing system are also known.

The method comprises measuring 202 a position of a calibration feature 102, using a measuring device of the additive manufacturing system. The measuring device may for example be a laser, and measuring 202 the position may comprise scanning the calibration feature with the measuring device.

The method further comprises determining 204 a relative position between the measuring device and the calibration feature, based on the measured position of the calibration feature. Since the positions of the measuring devices are known, and the relative position between the measuring device its corresponding calibration feature can be determined once the position of the calibration within the additive manufacturing system is known.

In some embodiments, the determining 204 a relative position between the measuring device and the calibration feature may comprise measuring the difference between an expected position of the calibration feature and a measured position of the calibration feature. In some embodiments, determining 204 a relative position may comprise measuring the difference between an expected position for where the measuring device is hitting the calibration feature and a measured position of where the measuring device is hitting the calibration feature.

Similar logic applies for the next step, which comprises determining 206 a relative position between the measuring device and each corresponding base device. Since the relative positions between the calibration feature and each corresponding base device are also known, the relative positions between the measuring device and its corresponding base devices may also be determined once the relative position between the measuring device and the calibration feature is known. In some embodiments, both determining steps 204, 206 may be performed substantially simultaneously, since the second step 206 follows straightforwardly once the first determining step 204 has been performed.

Once the relative positions between the measuring devices and each corresponding base device is known, it may be determined if there are any detected anomalies or deviations from expected behavior in the additive manufacturing system.

The method further comprises calibrating 208 the additive manufacturing system, based on the determined relative positions. The calibrating 208 comprises adjusting the additive manufacturing system, such that any detected anomalies or deviations between expected behavior and measured behavior is taken into account.

The calibrating 208 may in some embodiments comprise adjusting software of the additive manufacturing system. The calibrating 208 may in some embodiments comprise adjusting hardware of the additive manufacturing system. The calibrating 208 may in some embodiments comprise adjusting both hardware and software of the additive manufacturing system.

In some embodiments, calibrating the software of the additive manufacturing system comprises adjusting the machining instructions to take the detected relative positions into account. In some embodiments, this may comprise adding a coordinate transform for coordinates used in the machining instructions.

In some embodiments, the calibrating 208 may comprise adjusting hardware of the additive manufacturing system. Adjusting the hardware may comprise moving the build plate of the additive manufacturing device, such that the expected position of the calibration feature and the measured position of the calibration features becomes the same, or at least closer to the same, position. In some embodiments, adjusting the hardware may comprise moving other components of the additive manufacturing system around as well, such as the measuring devices or the base devices.

As will be understood, in case there are no detected anomalies or deviations, the calibrating 208 may comprise not adjusting the additive manufacturing system.

Thus, after the calibrating step 208, the additive manufacturing system has been calibrated such that it is operable for manufacturing an article. Given the precision required to successfully manufacture hybrid articles, it is important to have precise information about the positions about the components in the additive manufacturing system.

In some embodiments, the method further comprises manufacturing 210 the hybrid article, using the calibrated additive manufacturing system. By having the determination and calibration steps, very precise knowledge regarding the relative position of the base devices and the measuring devices is obtained, and thus the subsequent manufacturing can be performed in an accurate and efficient manner.

As described previously, the build plate may in some embodiments comprise a plurality of calibration features, a plurality of measuring devices and a plurality of base devices, wherein each calibration feature has a corresponding measuring device and at least one corresponding base device, preferably a plurality of corresponding base devices.

Thus, in some embodiments, measuring 202 the position of at least one calibration feature may comprise measuring the position of each of a plurality of calibration features, the determining 204 comprises determining a relative position between each measuring device and each calibration feature, and the determining 206 comprises determining a relative position between each measuring device and its corresponding base devices. In some embodiments, the method may comprise determining the relative position between each measuring device and each calibration feature. In some embodiments, the method may comprise determining the relative position between each measuring device and each base device.

In some embodiments, each measuring device is a laser, each calibration feature comprises at least one edge, and the measuring 202 comprises scanning an edge of a calibration feature with the laser. In some embodiments, the measuring comprises scanning at least two edges of the calibration feature with the laser.

In some embodiments, the measuring 202 comprises imprinting a pattern on the calibration feature, and then measuring any differences between the expected shape of the imprinted pattern with the measured imprinted pattern.

In some embodiments, the method comprises performing the measuring 202 in a heated state of the additive manufacturing system, which is the same or at least close to the working temperature of the additive manufacturing system. Thermal expansion may cause slight changes in positions and behaviors of the components in the additive manufacturing system, and by performing the measuring 202 in a relatively hot state, this may be taken into account. Since the subsequent steps are based on the measuring, they will also take that into account. Thus, in some embodiments, the method may comprise heating 201 the additive manufacturing system, prior to the measuring.

In some embodiments, the method may comprise first performing steps 202, 204 and 206, then heating 201 the additive manufacturing system, and then performing steps 202, 204, 206, 208 and 210. By doing this, differences in positions and/or behavior due to increased temperature may be determined, and this information may be used for the calibrating step 208.

An example of an additive manufacturing system 600 according to an embodiment, operable for performing methods according to the present disclosure will now be described.

The additive manufacturing system 600 comprises an additive manufacturing device suitable for performing the method steps according to the present disclosure. Such an additive manufacturing device comprises at least one measuring device, means for supplying powder, and means for fusing the powder together. As will be understood, the additive manufacturing device may further comprise additional components as well. The additive manufacturing system 600 further comprises a build plate comprising at least one calibration feature.

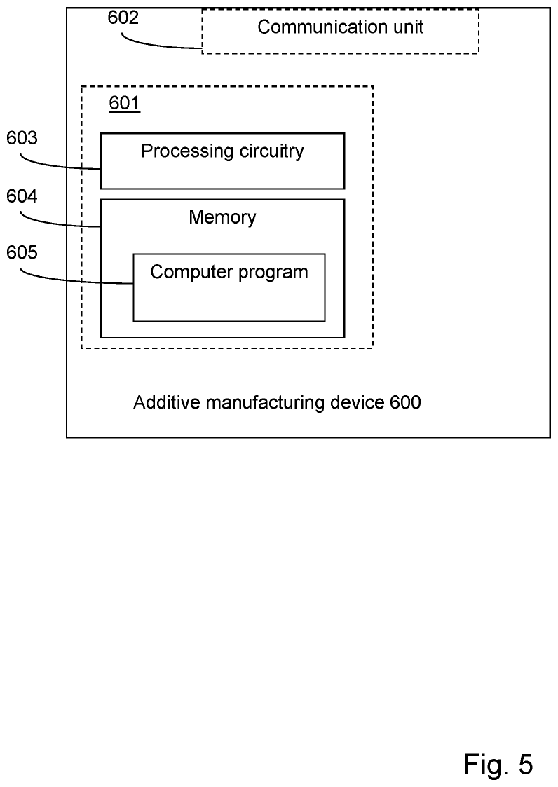

Looking now at FIG. 5, a block schematic of parts of the additive manufacturing system 600 according to an embodiment is shown. The additive manufacturing system 600 comprises processing circuitry 603 and a memory 604. The processing circuitry 603 may comprise one or more programmable processor, application-specific integrated circuits, field programmable gate arrays or combinations of these (not shown) adapted to execute instructions. The memory contains instructions executable by said processing circuitry, whereby the additive manufacturing system 600 is operative for measuring a position of the at least one calibration feature using the at least one measuring device and determining a relative position between the measuring device the at least one calibration feature. The additive manufacturing system 600 is further operative for determining the relative position between the measuring device and each corresponding base device, based on the relative position between the measuring device and the calibration feature, and for calibrating the additive manufacturing system based on the determined relative positions. In some embodiments, the additive manufacturing system 600 is further operative for manufacturing an article.

The additive manufacturing system 600 that performs the method may be a group of devices, wherein functionality for performing the method are spread out over different physical, or virtual, devices of the system. In other words, the additive manufacturing system 600 may be a cloud-solution, i.e. the additive manufacturing system 600 may be deployed as cloud computing resources that may be distributed in the system.

According to an embodiment, the additive manufacturing system 600 is further operative for performing any other of the method steps described herein.

According to other embodiments, the additive manufacturing system 600 may further comprise a communication unit 602, which may be considered to comprise conventional means for communicating with other parts of an additive manufacturing system. The instructions executable by said processing circuitry 603 may be arranged as a computer program 605 stored e.g. in the memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above.

The computer program 605 may comprise computer readable code means, which when run in an additive manufacturing system 600 causes the additive manufacturing system 600 to perform the steps described in any of the described embodiments of the additive manufacturing system 600. The computer program 605 may be carried by a computer program product connectable to the processing circuitry 603. The computer program product may be the memory 604. The memory 604 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 604. Alternatively, the computer program may be stored on a server or any other entity connected to the additive manufacturing system 600, to which it has access via the communication unit 602. The computer program may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method for calibrating an additive manufacturing system for manufacturing a hybrid article, the additive manufacturing system comprising:
at least one measuring device;
a build plate including at least one fixture having a base device, and at least one calibration feature, wherein the calibration feature is arranged to have its position determined by the at least one measuring device; and
wherein the method comprises:
measuring a position of the at least one calibration feature using the at least one measuring device;
determining a relative position between the measuring device and the at least one calibration feature;
determining a relative position between the measuring device and each corresponding base device, based on the relative position between the measuring device and the calibration feature; and
calibrating the additive manufacturing system based on the determined relative positions.

2. The method according to claim 1, further comprising manufacturing the hybrid article using the calibrated additive manufacturing system.

3. The method according to claim 1, wherein:
the manufacturing system includes a plurality of measuring devices;
the build plate includes a plurality of calibration features and a plurality of base devices, wherein each base device has a corresponding calibration feature and wherein each calibration feature has a corresponding laser;
wherein the measuring step includes measuring the position for each calibration feature using the corresponding measuring device;
wherein determining a relative position between the measuring device and the at least one calibration feature includes determining a relative position between each measuring device and its corresponding calibration feature, based on the measured position of each calibration feature; and
wherein determining a relative position between the measuring device and each corresponding base device includes determining a relative position between each measuring device and its corresponding base devices.

4. The method according to claim 1, wherein:
each measuring device is a laser;
each calibration feature includes an edge, and a surrounding clearance; and
wherein measuring the position of each calibration feature includes scanning the edge of the calibration feature with the laser.

5. The method according to claim 1, wherein:
the additive manufacturing system includes four lasers; and
the build plate includes four calibration features and each calibration feature has a plurality of corresponding base devices.

6. The method according to claim 1, wherein the calibration features are positioned in proximity of the corners of the build plate.

7. The method according to claim 1, wherein each calibration feature includes a heat resistant material.

8. A build plate for an additive manufacturing system, the additive manufacturing system including at least one measuring device, the build plate comprising:
at least one calibration feature arranged to have its position determined by the at least one measuring device; and
at least one fixture for a base device, wherein each base device, when attached to a fixture, has at least one corresponding calibration feature, and wherein each calibration feature has a corresponding measuring device.

9. The build plate according to claim 8, comprising one calibration feature for each measuring device of the additive manufacturing system.

10. The build plate according to claim 8, wherein the calibration feature includes a clearing around it, and further comprises at least one edge.

11. The build plate according to claim 8, wherein the calibration feature includes a material which can be imprinted upon by the measuring device.

12. An additive manufacturing system, comprising:
at least one additive manufacturing device;
a build plate including at least one fixture having a base device, and at least one calibration feature;
processing circuitry; and
a memory, said memory containing instructions executable by said processing circuitry, whereby said additive manufacturing system is operative for:
measuring a position of the at least one calibration feature using the at least one measuring device;
determining a relative position between the measuring device the at least one calibration feature;
determining the relative position between the measuring device and each corresponding base device, based on the relative position between the measuring device and the calibration feature; and
calibrating the additive manufacturing system based on the determined relative positions.

13. The additive manufacturing system according to claim 12, further operative for manufacturing a hybrid article using the calibrated additive manufacturing system.

14. A computer program comprising computer readable code means to be run in the additive manufacturing system, which computer readable code means when run in the additive manufacturing system causes the additive manufacturing system to perform the following steps:
measuring a position of the at least one calibration feature using the at least one measuring device;
determining a relative position between the measuring device the at least one calibration feature;
determining the relative position between the measuring device and each corresponding base device, based on the relative position between the measuring device and the calibration feature; and
calibrating the additive manufacturing system based on the determined relative positions.

15. A carrier containing the computer program according to claim 14, wherein the carrier is one of an electronic signal, optical signal, radio signal or computer readable storage medium.

16. The additive manufacturing system according to claim 12, comprising a plurality of measuring devices, a build plate including a plurality of calibration features and a plurality of base devices, wherein each base device has a corresponding calibration feature and wherein each calibration feature has a corresponding laser, wherein the measuring step includes measuring the position for each calibration feature using the corresponding measuring device, wherein determining a relative position between the measuring device the at least one calibration feature includes determining a relative position between each measuring device and its corresponding calibration feature, based on the measured position of each calibration feature, and wherein determining a relative position between the measuring device and each corresponding base device includes determining a relative position between each measuring device and its corresponding base devices.

17. The additive manufacturing system according to claim 12, wherein each measuring device is a laser, wherein each calibration feature includes an edge and a surrounding clearance, and wherein the step of measuring the position of each calibration feature includes scanning the edge of the calibration feature with the laser.

18. The additive manufacturing system according to claim 17, comprising four lasers, and wherein the build plate includes four calibration features and each calibration feature has a plurality of corresponding base devices.

19. The additive manufacturing system according to claim 18, wherein the calibration features are positioned in proximity of the corners of the build plate.
